(19) United States
(12) Patent Application Publication
(10) Pub. No.: US 2021/0357329 A1
(43) Pub. Date: Nov. 18, 2021

(54) MEMORY SYSTEM

(71) Applicant: SK hynix Inc., Icheon (KR)

(72) Inventor: Se Eun OH, Icheon (KR)

(21) Appl. No.: 17/031,109

(22) Filed: Sep. 24, 2020

(30) Foreign Application Priority Data
May 15, 2020 (KR) 10-2020-0058458

(51) Int. Cl. G06F 12/0811; G06F 12/0891

(52) U.S. Cl. CPC G06F 12/0811; G06F 2212/1021; G06F 12/0891

(57) ABSTRACT

A memory system may include a storage medium, a first cache, a second cache, and a control unit suitable for preferentially or selectively storing, in the first cache, write data corresponding to a write request received from a host device and preferentially or selectively checking the second cache in response to a read request received from the host device.

### CROSS-REFERENCES TO RELATED APPLICATION

The present application claims priority under 35 U.S.C. § 119(a) to Korean application number 10-2020-0058458, filed on May 15, 2020, in the Korean Intellectual Property Office, which is incorporated herein by reference in its entirety.

### BACKGROUND

### 1. Technical Field

Various embodiments generally relate to a memory system, and more particularly, to a memory system including a nonvolatile memory device.

### 2. Related Art

A memory system may be configured to store data provided by a host device in response to a write request received from the host device. Furthermore, the memory system may be configured to provide stored data to the host device in response to a read request received from the host device. The host device is an electronic device capable of processing data, and may include a computer, a digital camera or a mobile phone. The memory system may be embedded in the host device or may be fabricated as a separate device and connected to the host device.

### SUMMARY

An embodiment provides a memory system that mitigates or prevents the wear or degradation of a cache (e.g., a nonvolatile memory) by minimizing write operations on or using the cache and thus improves the cache hit rate of a multi-level cache, among other benefits.

In an embodiment, a memory system may include a storage medium; a first cache; a second cache; and a control unit configured to: preferentially store write data corresponding to a write request received from a host device in the first cache; and preferentially check the second cache in response to a read request received from the host device.

In an embodiment, a memory system may include a storage medium; a first cache; a second cache; and a control unit configured to: evict a hot data segment stored in the first cache to the second cache; and evict a cold data segment stored in the first cache to the storage medium.

In an embodiment, a method of operating a memory system having a first cache, a second cache, and a storage medium may include tracking an access count of a data segment stored in the first cache; determining the data segment as a hot data segment, a warm data segment, or a cold data segment, based on the access count; and evicting the data segment stored in the first cache to the second cache when the data segment is determined to be the hot data segment, or evicting the data segment stored in the first cache to the storage medium when the data segment is determined to be the cold data segment.

### BRIEF DESCRIPTION OF THE DRAWINGS

FIG. 1 is a block diagram illustrating a memory system according to an embodiment.

FIGS. 2A and 2B are diagrams illustrating a method of managing, by a controller, data segments stored in a first cache according to an embodiment.

FIGS. 3A and 3B are diagrams illustrating a method of evicting a data segment from the first cache according to an embodiment.

FIGS. 4A and 4B are diagrams illustrating a method of evicting a data segment from a second cache according to an embodiment.

FIG. 5 is a diagram illustrating a method of processing a write request received from a host device according to an embodiment.

FIG. 6 is a diagram illustrating a method of processing a read request received from the host device according to an embodiment.

FIG. 7 is a flow diagram illustrating a method of evicting, by the controller, a data segment from the first cache according to an embodiment.

FIG. 8 is a flow diagram illustrating a method of evicting, by the controller, a data segment from the second cache according to an embodiment.

FIG. 9 is a flow diagram illustrating a method of processing, by the controller, a write request according to an embodiment.

FIG. 10 is a flow diagram illustrating a method of processing, by the controller, a read request according to an embodiment.

FIG. 11 is a diagram illustrating a data processing system including a solid state drive (SSD) in accordance with an embodiment.

FIG. 12 is a diagram illustrating a data processing system including a memory system in accordance with an embodiment.

FIG. 13 is a diagram illustrating a data processing system including a memory system in accordance with an embodiment.

FIG. 14 is a diagram illustrating a network system including a memory system in accordance with an embodiment.

FIG. 15 is a block diagram illustrating a nonvolatile memory device included in a memory system in accordance with an embodiment.

### DETAILED DESCRIPTION

Advantages and characteristics of this disclosure and methods of achieving them will be described through embodiments to be described later in detail along with the accompanying drawings. However, this disclosure is not limited to the embodiments described herein, and may be materialized in other forms. The present embodiments are provided to describe this disclosure in detail to the extent that a person having ordinary skill in the art may readily carry out the technical spirit of this disclosure.

In the drawings, embodiments of the present disclosure are not limited to specific forms illustrated in the drawings and have been exaggerated for clarity. Specific terms have been used in the specification, but the terms are used to only describe the present disclosure, not to limit the meaning of the terms or the scope of right of the present disclosure written in the claims.

In the specification, an expression “and/or” is used as a meaning including at least one of elements listed front and back. Furthermore, an expression “connected/coupled” is used as a meaning including that one element is directly connected to another element and that the two elements are indirectly connected through a still another element. In the specification, the singular form includes the plural form unless specially described otherwise. Furthermore, terms, such as “includes or comprises” and/or “including or comprising” used in the specification, mean the existence or addition of one or more other elements, steps, operations and/or devices, in addition to the described elements, steps, operations and/or devices.

Hereinafter, embodiments are described in detail with reference to the accompanying drawings.

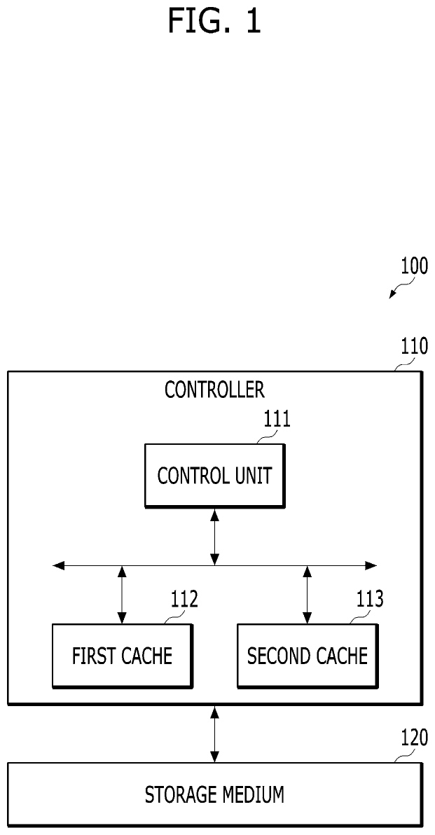

FIG. 1 is a block diagram of a memory system 100 according to an embodiment.

Referring to FIG. 1, the memory system 100 may be configured to store data provided by an external host device in response to a write request received from the host device. Furthermore, the memory system 100 may be configured to provide stored data to the host device in response to a read request received from the host device.

The memory system 100 may include a personal computer memory card international association (PCMCIA) card, a compact flash (CF) card, a smart media card, a memory stick, various multimedia cards (e.g., MMC (MultiMediaCard), eMMC (embedded MMC), RS-MMC (Reduced Size MMC), and MMC-micro), secure digital (SD) cards (e.g., SD, Mini-SD, and Micro-SD), a universal flash storage (USF), and/or a solid state drive (SSD).

The memory system 100 may include a controller 110 and storage medium 120. In an embodiment, the controller 110 is a digital circuit that manages the flow of data going to and from the storage medium 120. The controller 110 may be formed on a chip independently or integrated with one or more other circuits.

The controller 110 may control an overall operation of the memory system 100. The controller 110 may control the storage medium 120 in order to perform a foreground operation in response to an instruction received from the host device. The foreground operation may include operations of writing data in the storage medium 120 and reading data from the storage medium 120 in response to access requests received from the host device (e.g., a write request and/or a read request).

Furthermore, the controller 110 may control the storage medium 120 when performing internal background operations (e.g., operations independently performed without instructions from the host device). The background operations may include a wear-leveling operation, a garbage collection operation, an erase operation, a read re-claim operation, and/or a refresh operation for the storage medium 120. Like the foreground operation, the background operation may include operations of writing data in the storage medium 120 and reading data from the storage medium 120.

The controller 110 may include a control unit 111, a first cache 112, and a second cache 113.

The control unit 111 may control an overall operation of the controller 110. The control unit 111 may control data segments having different temperatures to be stored in the first cache 112 and the second cache 113 in order to efficiently process an access request from the host device. Further, the control unit 111 may preferentially or selectively access the first cache 112 and/or the second cache 113 in response to the access request.

Specifically, when receiving, from the host device, data corresponding to a write request, the control unit 111 may preferentially or selectively store the received data in the first cache 112. The data may be stored in the first cache 112 in a data segment unit.

Furthermore, the control unit 111 may manage the access counts of data segments stored in the first cache 112. An access count for a data segment may be increased when a read request for the data segment is received from the host device. The control unit 111 may determine the data segment, stored in the first cache 112, to be a hot data segment, a warm data segment, and/or a cold data segment, based on the corresponding or associated access count. In other words, the control unit 111 may determine a temperature of a data segment based on an access count for the data segment.

The control unit 111 may move a data segment based on a temperature of or assigned to the data segment. Specifically, when a given first cache eviction condition is satisfied, the control unit 111 may evict to the second cache 113 a hot data segment stored in the first cache 112, and may evict to the storage medium 120 a cold data segment stored in the first cache 112. In such a case, only a warm data segment may be left in the first cache 112.

The control unit 111 may preferentially or selectively check the second cache 113 in response to a read request received from the host device. When a cache hit occurs in the second cache 113, the control unit 111 may transmit to the host device data stored in the second cache 113. When a cache miss occurs in the second cache 113, the control unit 111 may check the first cache 112. When a cache hit occurs in the first cache 112, the control unit 111 may transmit to the host device data stored in the first cache 112. When a cache miss occurs in the first cache 112, the control unit 111 may transmit to the host device data stored in the storage medium 120.

The first cache 112 and the second cache 113 may each operate at a higher access speed than the storage medium 120, and each may be used as a multi-level cache.

According to an embodiment, the first cache 112 may operate at a higher write speed than the second cache 113. Accordingly, the first cache 112 may store data more rapidly or quickly in response to a write request for the data.

According to an embodiment, the second cache 113 may have a higher memory capacity than the first cache 112. Accordingly, the second cache 113 may store many hot data segments (e.g., more hot data segments as compared to the first cache 112).

According to an embodiment, each of the first cache 112 and/or the second cache 113 may include a volatile memory device. The volatile memory device may include a dynamic random access memory (DRAM), a static random access memory (SRAM), and so on.

According to an embodiment, each of the first cache 112 and/or the second cache 113 may include a nonvolatile memory device. The nonvolatile memory device may include a flash memory device, such as a NAND flash or a NOR flash, a ferroelectrics random access memory (FeRAM), a phase-change random access memory (PCRAM), a magnetic random access memory (MRAM), a resistive random access memory (ReRAM), and so on.

According to an embodiment, the first cache 112 may be a DRAM, and the second cache 113 may be a PCRAM.

As a result, a cache hit rate can be increased by storing a hot data segment in the second cache 113 and preferentially or selectively checking the second cache 113 in response to a read request. Thus, the wear or degradation of the second cache 113 can be mitigated because write operations for or associated with the second cache 113 are minimized or reduced.

The storage medium 120 may store data transmitted by the controller 110, may read stored data, and/or may transmit the read data to the controller 110, under the control of the controller 110.

The storage medium 120 may have a higher memory capacity than the first cache 112 and/or the second cache 113.

The storage medium 120 may include a flash memory device, such as a NAND flash or a NOR flash, a ferroelectrics random access memory (FeRAM), a phase-change random access memory (PCRAM), a magnetic random access memory (MRAM), a resistive random access memory (ReRAM), and so on.

The storage medium 120 may include one or more planes, one or more memory chips, one or more memory dies, or one or more memory packages.

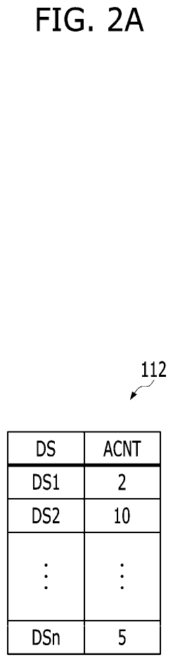

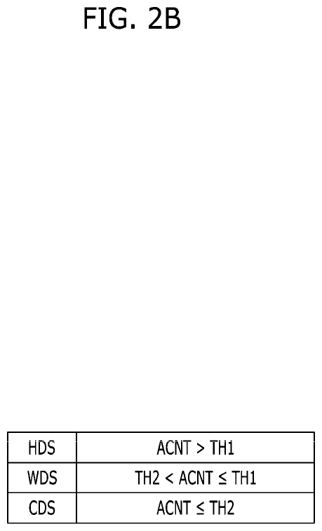

FIGS. 2A and 2B are diagrams illustrating a method of managing, by the control unit 111, data segments DS stored in the first cache 112, according to an embodiment.

Referring to FIG. 2A, the data segment DS may be a unit by which data is stored in and evicted from the first cache 112 and/or the second cache 113. For example, the first cache 112 may store data segments DS1 to DSn.

The control unit 111 may manage or track access counts ACNT for the respective data segments DS stored in the first cache 112. Specifically, when storing a data segment DS in the first cache 112, the control unit 111 may set the access count ACNT of the data segment DS to 0. When receiving a read request for a data segment DS, the control unit 111 may increase the access count ACNT of the data segment DS (e.g., increase ACNT by 1 for each read request). In other words, when a cache hit occurs in a data segment DS, the control unit 111 may increase the access count ACNT of the data segment DS.

Referring to FIG. 2B, the control unit 111 may determine a temperature of a data segment DS based on a corresponding or associated access count ACNT, in order to evict the data segment DS from the first cache 112 to the second cache 113 and/or the storage medium 120.

Specifically, the control unit 111 may determine a data segment DS as a hot data segment HDS, a warm data segment WDS, and/or a cold data segment CDS, by comparing a corresponding or associated access count ACNT with a first threshold TH1 and/or a second threshold TH2, where the second threshold TH2 is smaller than the first threshold TH1. Specifically, when the access count ACNT exceeds the first threshold TH1, the control unit 111 may determine the data segment DS as a hot data segment HDS. When the access count ACNT exceeds the second threshold TH2, but does not exceed the first threshold TH1, the control unit 111 may determine the data segment DS as a warm data segment WDS. When the access count ACNT does not exceed the second threshold TH2, the control unit 111 may determine the data segment DS as a cold data segment CDS.

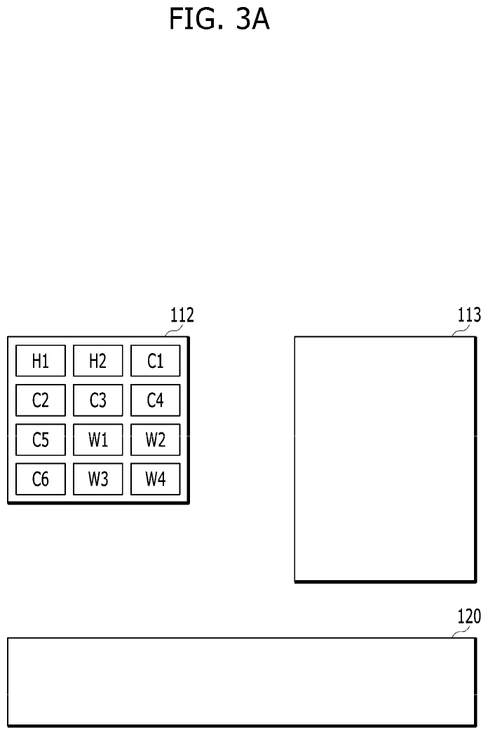

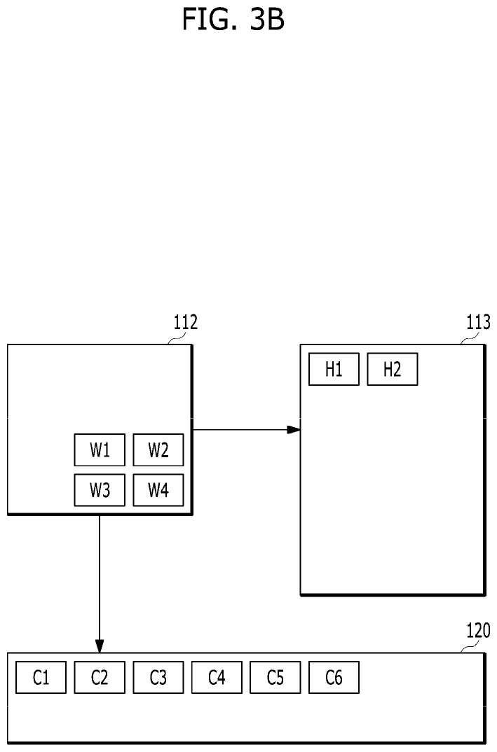

FIGS. 3A and 3B are diagrams illustrating a method of evicting a data segment from the first cache 112 to the second cache 113 or the storage medium 120 according to an embodiment.

Referring to FIG. 3A, when a given first cache eviction condition is satisfied, the control unit 111 may evict a data segment from the first cache 112. For example, the first cache eviction condition may include: when a write request is received from the host device, when the first cache 112 is full, and/or when the number of data segments stored in the first cache 112 exceeds a given or threshold number. According to an embodiment, when two or more first cache eviction conditions are satisfied, the control unit 111 may evict a data segment from the first cache 112.

The control unit 111 may determine a data segment to be evicted from the first cache 112 based on a temperature of the data segment stored in the first cache 112. Specifically, the control unit 111 may determine to evict a hot data segment and a cold data segment from all the data segments stored in the first cache 112. According to an embodiment, the control unit 111 may determine to evict a hot data segment or a cold data segment from all the data segments stored in the first cache 112.

Furthermore, the control unit 111 may determine where to evict a data segment, stored in the first cache 112, based on a temperature of the data segment. Specifically, the control unit 111 may evict to the second cache 113 a hot data segment stored in the first cache 112, and may evict to the storage medium 120 a cold data segment stored in the first cache 112.

As a result, referring to FIG. 3B, warm data segments W1 to W4 may remain in the first cache 112. Hot data segments H1 and H2 may be moved from the first cache 112 to the second cache 113. Cold data segments C1 to C6 may be moved from the first cache 112 to the storage medium 120.

When evicting a data segment stored in the first cache 112 to the second cache 113, the control unit 111 may store a corresponding or associated access count in the second cache 113 without resetting the access count, and may continue to manage the corresponding access count.

As a result, in general, a ratio of the hot data segments to all the data is the smallest. Accordingly, if only the hot data segments H1 and H2 are stored in the second cache 113, a write count or frequency of writes for the second cache 113 can be significantly reduced compared to a case where only the hot data segments H1 and H2 are not stored in the second cache 113. Accordingly, if the second cache 113 is a nonvolatile memory device, the lifespan of the second cache 113 can be increased, and performance of the memory system 100 can be improved.

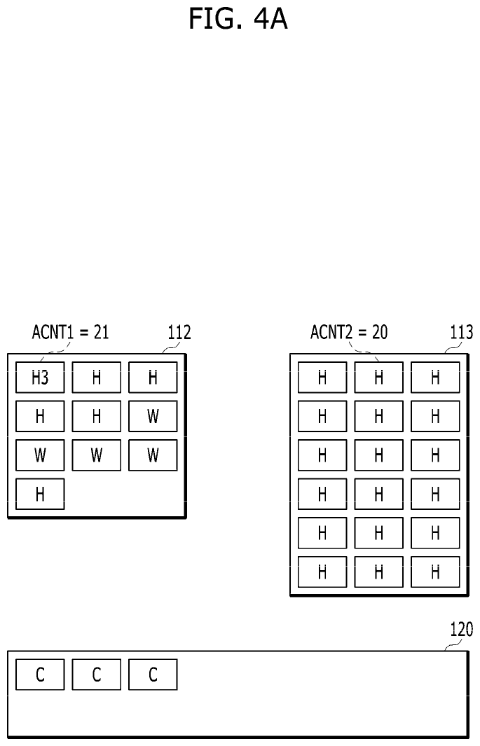

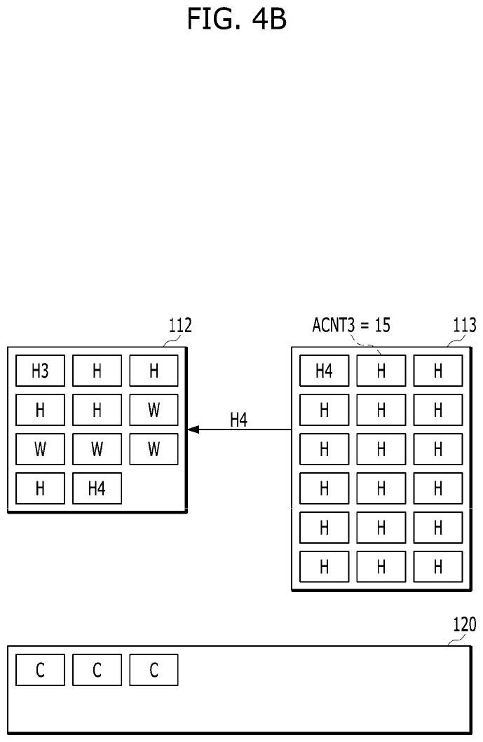

FIGS. 4A and 4B are diagrams illustrating a method of evicting a data segment from the second cache 113 according to an embodiment. In FIGS. 4A and 4B, H is a hot data segment, W is a warm data segment, and C is a cold data segment.

Referring to FIG. 4A, when a second cache eviction condition is satisfied, the control unit 111 may evict a data segment from the second cache 113. For example, the second cache eviction condition may include: when the second cache 113 is full, when the number of data segments stored in the second cache 113 exceeds a given number or threshold, when a given time elapses after the second cache 113 is full, when a hot data segment is determined to be evicted from the first cache 112, and/or when a hotter data segment is present in the first cache 112. According to an embodiment, when two or more second cache eviction conditions are satisfied, the control unit 111 may evict a data segment from the second cache 113.

A case where a hotter data segment is present in the first cache 112 (e.g., a second cache eviction condition), will be described in detail below. As described herein, first, when evicting, a data segment stored in the first cache 112 to the second cache 113, the control unit 111 may store a corresponding access count in the second cache 113 without resetting the access count, and may continue to manage the access count. When receiving a read request for a data segment stored in the second cache 113, the control unit 111 may increase an access count corresponding to the data segment in the second cache 113.

Furthermore, the control unit 111 may determine a maximum access count ACNT1 of the first cache 112 and a maximum access count ACNT2 of the second cache 113. When the maximum access count ACNT1 of the first cache 112 is greater than the maximum access count ACNT2 of the second cache 113, the control unit 111 may determine that a hotter data segment (e.g., a data segment H3 corresponding to the maximum access count ACNT1 of the first cache 112) is present in the first cache 112. Accordingly, in order to evict, the hotter data segment H3 stored in the first cache 112 to the second cache 113, the control unit 111 may previously evict a data segment from the second cache 113 and generate an empty region in the second cache 113.

Referring to FIG. 4B, the control unit 111 may determine a minimum access count ACNT3 of the second cache 113, and may evict a data segment H4 corresponding to the minimum access count ACNT3 to the first cache 112. That is, the data segment H4 is a relatively warm data segment in the second cache 113, and thus may be evicted to the first cache 112.

Thus, the second cache eviction condition may be set to minimize a write operation for the second cache 113. Accordingly, when the second cache 113 is a nonvolatile memory device, the lifespan of the second cache 113 can be increased, and performance of the memory system 100 can be improved.

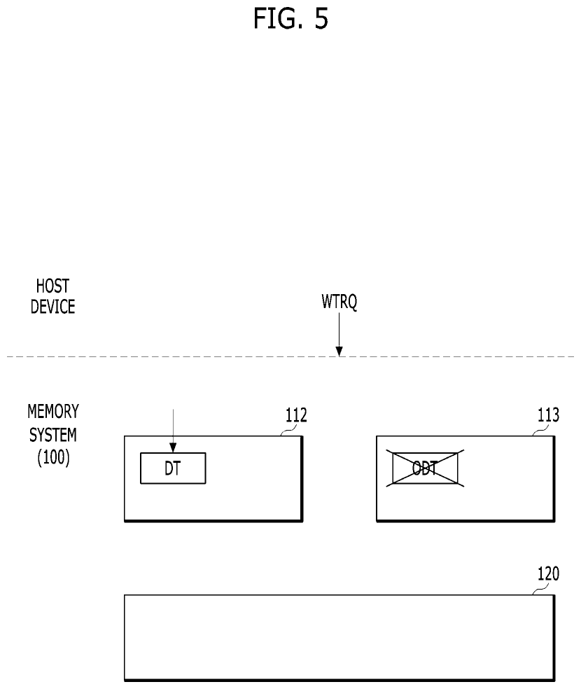

FIG. 5 is a diagram illustrating a method of processing a write request WTRQ from the host device according to an embodiment.

Referring to FIG. 5, the control unit 111 may receive the write request WTRQ from the host device, and may preferentially or selectively store, in the first cache 112, data DT corresponding to the write request WTRQ. That is, the data DT may be first stored in the first cache 112, which has a higher write speed than the second cache 113 and/or the storage medium 120.

At this time, if old data ODT corresponding to the same logical address as the data DT (e.g., a previous version of the data DT) has already been stored in the second cache 113, the control unit 111 may invalidate or delete the old data ODT.

Thereafter, the data DT may be evicted to the second cache 113 or the storage medium 120 when the first cache eviction condition is satisfied, as described with reference to FIGS. 3A and 3B.

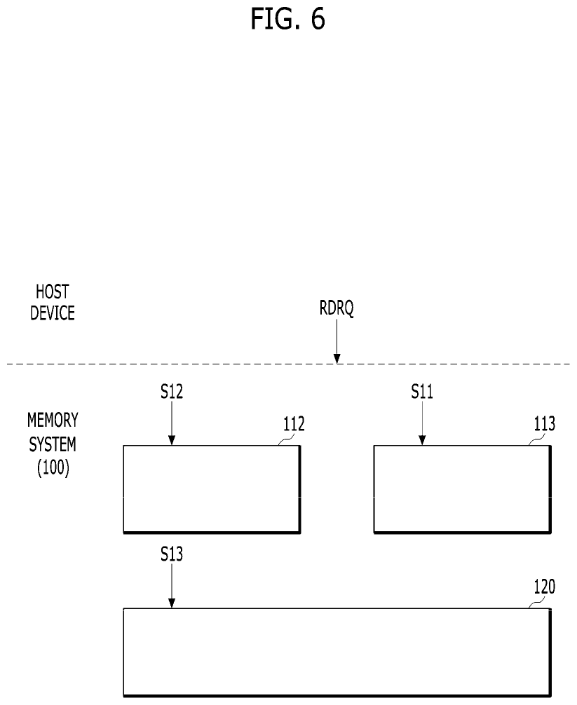

FIG. 6 is a diagram illustrating a method of processing a read request RDRQ from the host device according to an embodiment.

Referring to FIG. 6, at step S11, the control unit 111 may first check whether a cache hit occurs in the second cache 113 (e.g., whether data corresponding to the read request RDRQ has been stored in the second cache 113), in response to the read request RDRQ received from the host device. When a cache hit occurs in the second cache 113, the control unit 111 may transmit, to the host device, data stored in the second cache 113. According to an embodiment, since the second cache 113 that caches only a hot data segment is preferentially checked, a cache hit rate can be improved.

When a cache miss occurs in the second cache 113, at step S12, the control unit 111 may check whether a cache hit occurs in the first cache 112. When a cache hit occurs in the first cache 112, the control unit 111 may transmit to the host device data stored in the first cache 112. At this time, the control unit 111 may directly transmit the data stored in the first cache 112 from the first cache 112 to the host device without moving the data to the second cache 113.

When a cache miss occurs in the first cache 112, at step S13, the control unit 111 may transmit to the host device data stored in the storage medium 120. At this time, the control unit 111 may directly transmit the data stored in the storage medium 120 from the storage medium 120 to the host device without moving the data to the first cache 112 or the second cache 113. Accordingly, no write operation for the first cache 112 or the second cache 113 occurs.

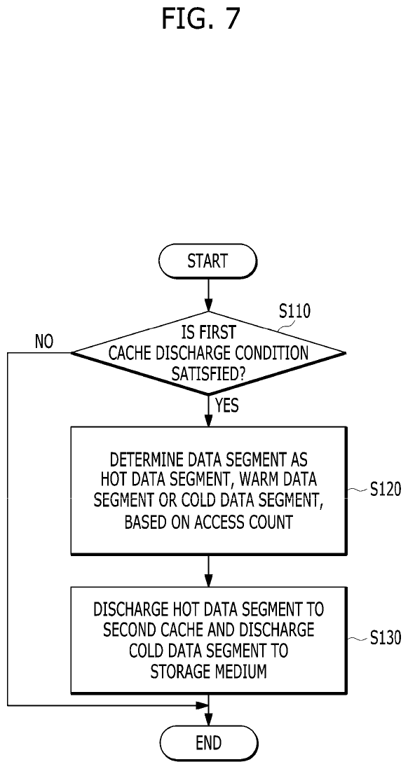

FIG. 7 is a flow diagram illustrating a method of evicting, by the control unit 111, a data segment from the first cache 112 according to an embodiment.

Referring to FIG. 7, at step S110, the control unit 111 may determine whether the first cache eviction condition is satisfied. When the first cache eviction condition is not satisfied, the method ends. When the first cache eviction condition is satisfied, the method may proceed to step S120.

At step S120, the control unit 111 may determine a data segment as a hot data segment, a warm data segment, or a cold data segment, based on the access count of the data segment stored in the first cache 112.

At step S130, the control unit 111 may evict, to the second cache 113, a hot data segment stored in the first cache 112, and may evict, to the storage medium 120, a cold data segment stored in the first cache 112.

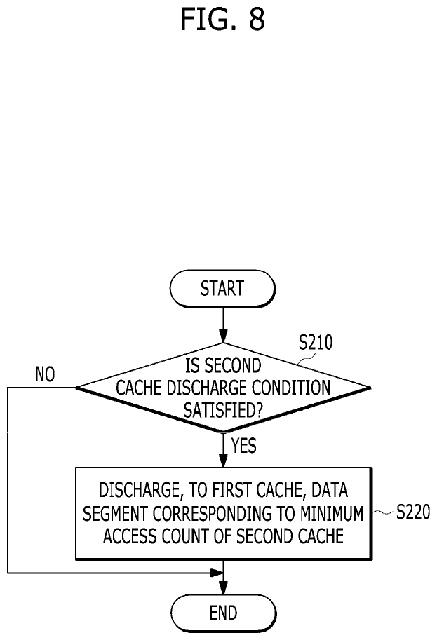

FIG. 8 is a flow diagram illustrating a method of evicting, by the control unit 111, a data segment from the second cache 113 according to an embodiment.

Referring to FIG. 8, at step S210, the control unit 111 may determine whether the second cache eviction condition is satisfied. When the second cache eviction condition is not satisfied, the method ends. When the second cache eviction condition is satisfied, the method may proceed to step S220.

At step S220, the control unit 111 may evict, to the first cache 112, a data segment corresponding to a minimum access count of the second cache 113.

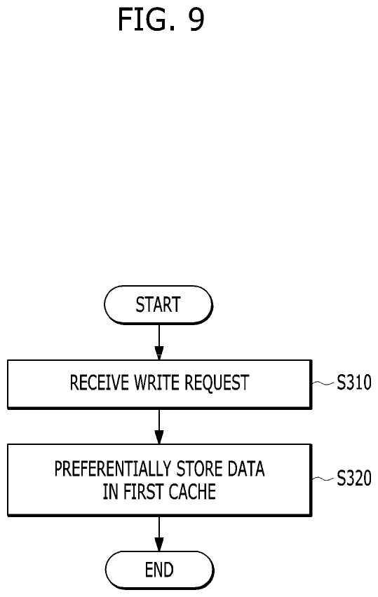

FIG. 9 is a flow diagram illustrating a method of processing, by the control unit 111, a write request according to an embodiment.

Referring to FIG. 9, at step S310, the control unit 111 may receive a write request from the host device.

At step S320, the control unit 111 may preferentially or selectively store data in the first cache 112.

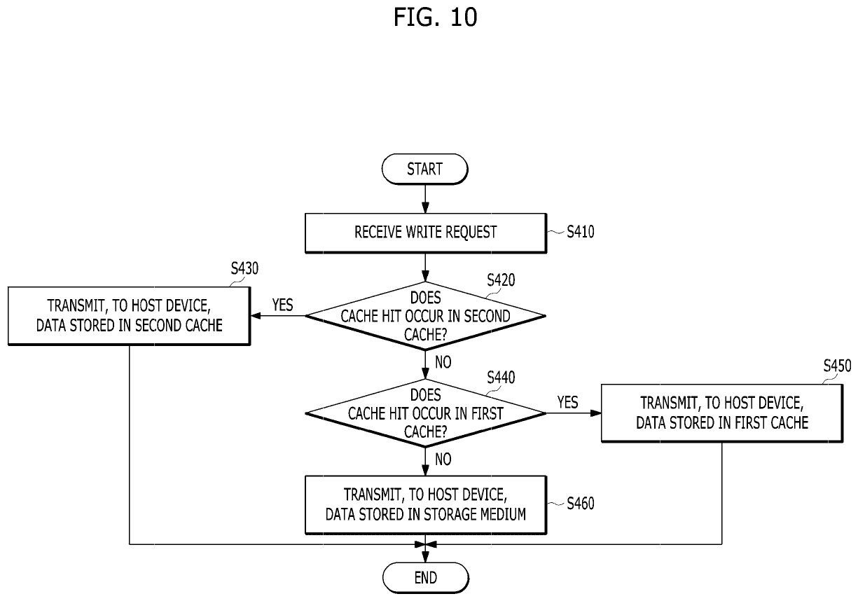

FIG. 10 is a flow diagram illustrating a method of processing, by the control unit 111, a read request according to an embodiment.

Referring to FIG. 10, at step S410, the control unit 111 may receive a read request from the host device.

At step S420, the control unit 111 may determine whether a cache hit occurs in the second cache 113, by preferentially checking the second cache 113. When the cache hit occurs in the second cache 113, the method may proceed to step S430. When the cache hit does not occur in the second cache 113, the method may proceed to step S440.

At step S430, the control unit 111 may transmit, to the host device, data stored in the second cache 113.

At step S440, the control unit 111 may determine whether the cache hit occurs in the first cache 112 by checking the first cache 112. When the cache hit occurs in the first cache 112, the method may proceed to step S450. When the cache hit does not occur in the first cache 112, the method may proceed to step S460.

At step S450, the control unit 111 may transmit to the host device data stored in the first cache 112. At this time, the control unit 111 may directly transmit the data stored in the first cache 112 from the first cache 112 to the host device without moving the data to the second cache 113.

At step S460, the control unit 111 may transmit, to the host device, data stored in the storage medium 120. At this time, the control unit 111 may directly transmit the data stored in the storage medium 120 from the storage medium 120 to the host device without moving the data to the first cache 112 or the second cache 113.

Thus, a memory system according to an embodiment can reduce the wear or degradation of a cache (e.g., nonvolatile memory) by minimizing write operations on the cache, and improve the cache hit rate of a multi-level cache.

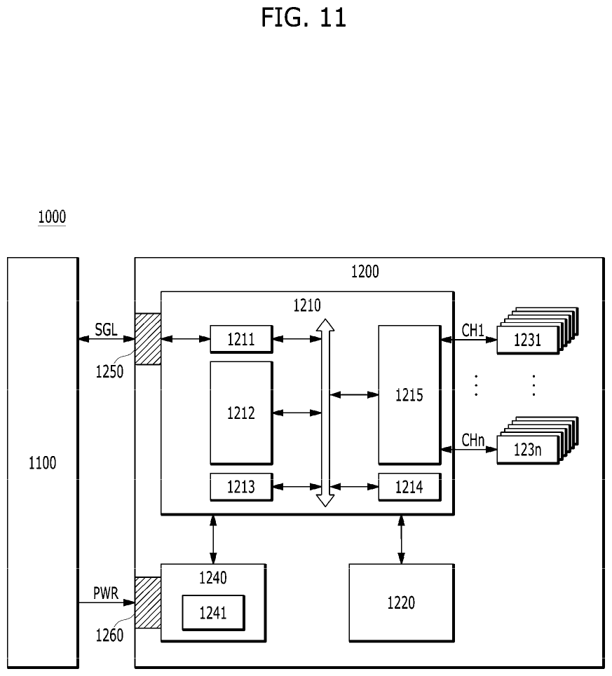

FIG. 11 is a diagram illustrating a data processing system 1000 including a solid state drive (SSD) 1200 in accordance with an embodiment. Referring to FIG. 11, the data processing system 1000 may include a host device 1100 and the SSD 1200.

The SSD 1200 may include a controller 1210, a buffer memory device 1220, a plurality of nonvolatile memory devices 1231 to 123n, a power supply 1240, a signal connector 1250, and a power connector 1260.

The controller 1210 may control general operations of the SSD 1200. The controller 1210 may include a host interface unit 1211, a control unit 1212, a random access memory 1213, an error correction code (ECC) unit 1214, and a memory interface unit 1215.

The host interface unit 1211 may exchange a signal SGL with the host device 1100 through the signal connector 1250. The signal SGL may include a command, an address, data, and so forth. The host interface unit 1211 may interface the host device 1100 and the SSD 1200 according to the protocol of the host device 1100. For example, the host interface unit 1211 may communicate with the host device 1100 through any one of standard interface protocols such as secure digital, universal serial bus (USB), multimedia card (MMC), embedded MMC (eMMC), personal computer memory card international association (PCMCIA), parallel advanced technology attachment (PATA), serial advanced technology attachment (SATA), small computer system interface (SCSI), serial attached SCSI (SAS), peripheral component interconnect (PCI), PCI express (PCI-E) and universal flash storage (UFS).

The control unit 1212 may analyze and process the signal SGL received from the host device 1100. The control unit 1212 may control operations of internal function blocks according to a firmware or a software for driving the SSD 1200. The control unit 1212 may be configured in the same manner as the control unit 111 shown in FIG. 1.

The random access memory 1213 may be used as a working memory for driving such a firmware or software. The random access memory 1213 may operate as a first cache of the SSD 1200. The random access memory 1213 may be configured in the same manner as the first cache 112 shown in FIG. 1.

The ECC unit 1214 may generate the parity data of data to be transmitted to at least one of the nonvolatile memory devices 1231 to 123n. The generated parity data may be stored together with the data in the nonvolatile memory devices 1231 to 123n. The ECC unit 1214 may detect an error of the data read from at least one of the nonvolatile memory devices 1231 to 123n, based on the parity data. If a detected error is within a correctable range, the ECC unit 1214 may correct the detected error.

The memory interface unit 1215 may provide control signals such as commands and addresses to at least one of the nonvolatile memory devices 1231 to 123n, according to control of the control unit 1212. Moreover, the memory interface unit 1215 may exchange data with at least one of the nonvolatile memory devices 1231 to 123n, according to control of the control unit 1212. For example, the memory interface unit 1215 may provide the data stored in the buffer memory device 1220, to at least one of the nonvolatile memory devices 1231 to 123n, or provide the data read from at least one of the nonvolatile memory devices 1231 to 123n, to the buffer memory device 1220.

The buffer memory device 1220 may temporarily store data to be stored in at least one of the nonvolatile memory devices 1231 to 123n. Further, the buffer memory device 1220 may temporarily store the data read from at least one of the nonvolatile memory devices 1231 to 123n. The data temporarily stored in the buffer memory device 1220 may be transmitted to the host device 1100 or at least one of the nonvolatile memory devices 1231 to 123n according to control of the controller 1210.

Meanwhile, the buffer memory device 1220 may operate as a second cache of the SSD 1200. The buffer memory device 1220 may be configured in the same manner as the second cache 113 shown in FIG. 1.

The nonvolatile memory devices 1231 to 123n may be used as storage media of the SSD 1200. The nonvolatile memory devices 1231 to 123n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1260, to the inside of the SSD 1200. The power supply 1240 may include an auxiliary power supply 1241. The auxiliary power supply 1241 may supply power to allow the SSD 1200 to be normally terminated when a sudden power-off occurs. The auxiliary power supply 1241 may include large capacity capacitors.

The signal connector 1250 may be configured by various types of connectors depending on an interface scheme between the host device 1100 and the SSD 1200.

The power connector 1260 may be configured by various types of connectors depending on a power supply scheme of the host device 1100.

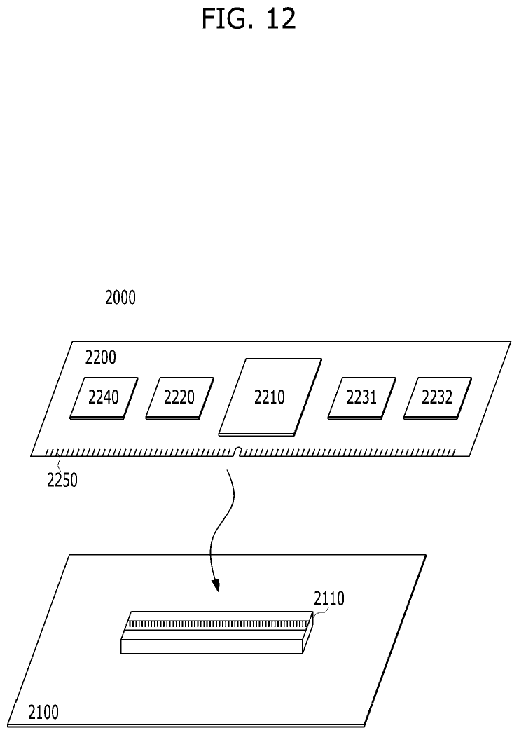

FIG. 12 is a diagram illustrating a data processing system 2000 including a memory system 2200 in accordance with an embodiment. Referring to FIG. 12, the data processing system 2000 may include a host device 2100 and the memory system 2200.

The host device 2100 may be configured in the form of a board such as a printed circuit board. Although not shown, the host device 2100 may include internal function blocks for performing the function of a host device.

The host device 2100 may include a connection terminal 2110 such as a socket, a slot or a connector. The memory system 2200 may be mounted to the connection terminal 2110.

The memory system 2200 may be configured in the form of a board such as a printed circuit board. The memory system 2200 may be referred to as a memory module or a memory card. The memory system 2200 may include a controller 2210, a buffer memory device 2220, nonvolatile memory devices 2231 and 2232, a power management integrated circuit (PMIC) 2240, and a connection terminal 2250.

The controller 2210 may control general operations of the memory system 2200. The controller 2210 may be configured in the same manner as the controller 1210 shown in FIG. 11.

The buffer memory device 2220 may temporarily store data to be stored in the nonvolatile memory devices 2231 and 2232. Further, the buffer memory device 2220 may temporarily store the data read from the nonvolatile memory devices 2231 and 2232. The data temporarily stored in the buffer memory device 2220 may be transmitted to the host device 2100 or the nonvolatile memory devices 2231 and 2232 according to control of the controller 2210.

The nonvolatile memory devices 2231 and 2232 may be used as storage media of the memory system 2200.

The PMIC 2240 may provide the power inputted through the connection terminal 2250, to the inside of the memory system 2200. The PMIC 2240 may manage the power of the memory system 2200 according to control of the controller 2210.

The connection terminal 2250 may be coupled to the connection terminal 2110 of the host device 2100. Through the connection terminal 2250, signals such as commands, addresses, data and so forth and power may be transferred between the host device 2100 and the memory system 2200. The connection terminal 2250 may be configured into various types depending on an interface scheme between the host device 2100 and the memory system 2200. The connection terminal 2250 may be disposed on any one side of the memory system 2200.

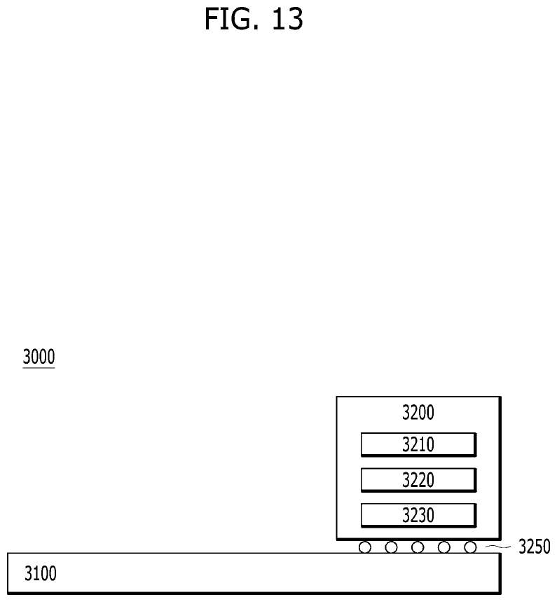

FIG. 13 is a diagram illustrating a data processing system 3000 including a memory system 3200 in accordance with an embodiment. Referring to FIG. 13, the data processing system 3000 may include a host device 3100 and the memory system 3200.

The host device 3100 may be configured in the form of a board such as a printed circuit board. Although not shown, the host device 3100 may include internal function blocks for performing the function of a host device.

The memory system 3200 may be configured in the form of a surface-mounting type package. The memory system 3200 may be mounted to the host device 3100 through solder balls 3250. The memory system 3200 may include a controller 3210, a buffer memory device 3220, and a nonvolatile memory device 3230.

The controller 3210 may control general operations of the memory system 3200. The controller 3210 may be configured in the same manner as the controller 1210 shown in FIG. 11.

The buffer memory device 3220 may temporarily store data to be stored in the nonvolatile memory device 3230. Further, the buffer memory device 3220 may temporarily store the data read from the nonvolatile memory device 3230. The data temporarily stored in the buffer memory device 3220 may be transmitted to the host device 3100 or the nonvolatile memory device 3230 according to control of the controller 3210.

The nonvolatile memory device 3230 may be used as the storage medium of the memory system 3200.

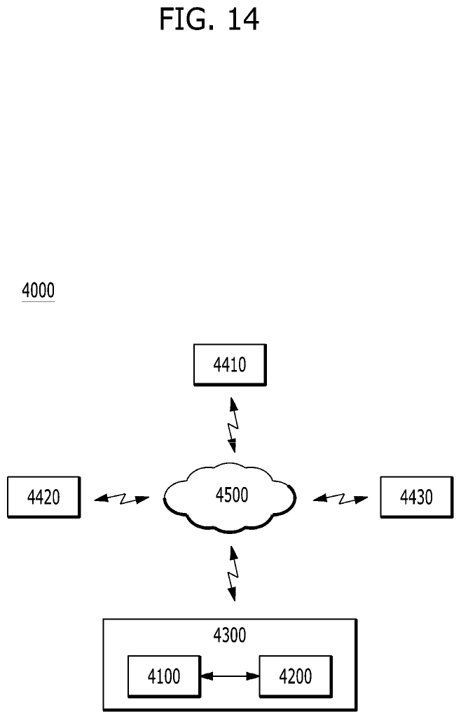

FIG. 14 is a diagram illustrating a network system 4000 including a memory system 4200 in accordance with an embodiment. Referring to FIG. 14, the network system 4000 may include a server system 4300 and a plurality of client systems 4410 to 4430 which are coupled through a network 4500.

The server system 4300 may service data in response to requests from the plurality of client systems 4410 to 4430. For example, the server system 4300 may store the data provided from the plurality of client systems 4410 to 4430. For another example, the server system 4300 may provide data to the plurality of client systems 4410 to 4430.

The server system 4300 may include a host device 4100 and the memory system 4200. The memory system 4200 may be configured by the memory system 100 shown in FIG. 1, the SSD 1200 shown in FIG. 11, the memory system 2200 shown in FIG. 12 or the memory system 3200 shown in FIG. 13.

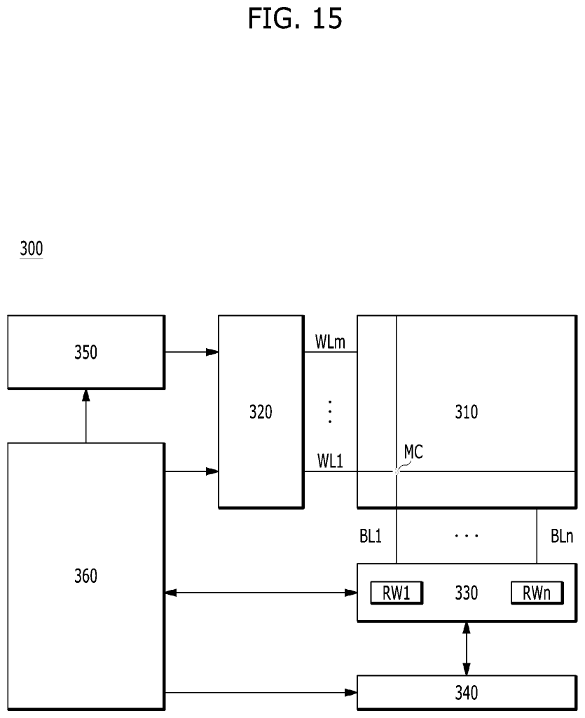

FIG. 15 is a block diagram illustrating a nonvolatile memory device 300 included in a memory system in accordance with an embodiment. Referring to FIG. 15, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

Those skilled in the art to which this disclosure pertains should understand that the embodiments described above are only illustrative from all aspects, not limitative, because this disclosure may be carried out in various other forms without changing the technical spirit or essential characteristics of this disclosure. The scope of this disclosure is defined by the appended claims rather than by the detailed description, and all modifications or variations derived from the meanings and scope of the claims and equivalent concepts thereof should be construed as being included in the scope of this disclosure.

What is claimed is:

1. A memory system, comprising:
a storage medium;
a first cache;
a second cache; and
a control unit configured to:
preferentially store write data corresponding to a write request received from a host device in the first cache; and
preferentially check the second cache in response to a read request received from the host device.

2. The memory system of claim 1, wherein, when a cache miss occurs in the second cache, the control unit checks the first cache in response to the read request from the host device.

3. The memory system of claim 2, wherein, when a cache hit occurs in the first cache, the control unit transmits from the first cache to the host device read data corresponding to the read request without first recovering the read data to the second cache.

4. The memory system of claim 1, wherein the control unit:
tracks access counts of data segments stored in the first cache; and
determines whether to evict the data segments to the second cache or the storage medium based on the access counts.

5. The memory system of claim 4, wherein, when evicting a data segment stored in the first cache to the second cache, the control unit stores an access count of the data segment in the second cache and continues to track the access count.

6. The memory system of claim 1, wherein the control unit evicts a hot data segment stored in the first cache to the second cache.

7. The memory system of claim 1, wherein the control unit evicts a cold data segment stored in the first cache to the storage medium.

8. The memory system of claim 1, wherein, when a maximum access count of the first cache is greater than a maximum access count of the second cache, the control unit evicts a data segment corresponding to a minimum access count of the second cache to the first cache.

9. The memory system of claim 1, wherein:
the second cache has a higher memory capacity than the first cache, and
the first cache operates at a higher write speed than the second cache.

10. A memory system, comprising:
a storage medium;
a first cache;
a second cache; and
a control unit configured to:
evict a hot data segment stored in the first cache to the second cache; and
evict a cold data segment stored in the first cache to the storage medium.

11. The memory system of claim 10, wherein the control unit:
manages an access count of a data segment stored in the first cache; and
determines the data segment as the hot data segment, a warm data segment, or the cold data segment, based on the access count.

12. The memory system of claim 11, wherein, when evicting the hot data segment to the second cache, the control unit stores an access count of the hot data segment in the second cache and continues to manage the access count.

13. The memory system of claim 10, wherein, when a maximum access count of the first cache is greater than a maximum access count of the second cache, the control unit evicts a data segment corresponding to a minimum access count of the second cache to the first cache.

14. The memory system of claim 10, wherein the control unit preferentially stores write data corresponding to a write request received from a host device in the first cache.

15. The memory system of claim 10, wherein the control unit preferentially checks the second cache in response to a read request received from the host device.

16. The memory system of claim 15, wherein, when a cache miss occurs in the second cache, the control unit checks the first cache.

17. The memory system of claim 16, wherein, when a cache hit occurs in the first cache, the control unit transmits from the first cache to the host device read data corresponding to the read request without recovering the read data to the second cache.

18. The memory system of claim 10, wherein:
the second cache has a higher memory capacity than the first cache, and
the first cache operates at a higher write speed than the second cache.

19. A method of operating a memory system having a first cache, a second cache, and a storage medium, the method comprising:
tracking an access count of a data segment stored in the first cache;
determining the data segment as a hot data segment, a warm data segment, or a cold data segment, based on the access count; and
evicting the data segment stored in the first cache to the second cache when the data segment is determined to be the hot data segment, or
evicting the data segment stored in the first cache to the storage medium when the data segment is determined to be the cold data segment.

20. The method of claim 19, wherein:
the second cache has a higher memory capacity than the first cache, and
the first cache operates at a higher write speed than the second cache.
